(19) United States
(12) Patent Application Publication
(10) Pub. No.: US 2004/0146679 A1
(43) Pub. Date: Jul. 29, 2004

(54) Automotive fuel hose

(75) Inventors: Junichiro Suzuki, Kasugai-shi (JP); Kazutaka Katayama, Kasugai-shi (JP); Hiroaki Ito, Kasugai-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKAI RUBBER INDUSTRIES, LTD., Komaki-shi (JP)

(21) Appl. No.: 10/757,453

(22) Filed: Jan. 15, 2004

(30) Foreign Application Priority Data
Jan. 16, 2003 (JP) JP2003-008730
Oct. 30, 2003 (JP) JP2003-370765

(51) Int. Cl. B32B 1/08

(52) U.S. Cl. 428/36.91

(57) ABSTRACT

An automotive fuel hose of low fuel permeability, and excellent in impact resistance, hydrolysis resistance, and inter-layer adhesion. The automotive fuel hose comprises: a tubular inner layer (1) in which fuel is adapted to flow, the inner layer comprising a fluororesin having a functional group; a low fuel permeability layer (3) provided about an outer peripheral surface of the inner layer comprising a polyester resin having a naphthalene ring; and an adhesive layer (2) for bonding the inner layer and the low fuel permeability layer comprising a blend of polyamide resin and polyester resin.

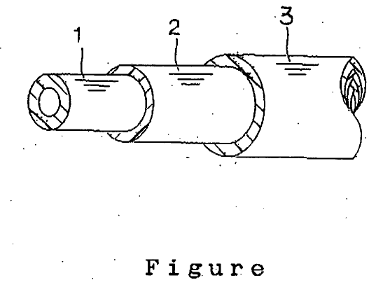

### BACKGROUND OF THE INVENTION

1. Field of the Invention

The present invention relates to an automotive fuel hose for transportation of an automotive fuel, and, more specifically, to an automotive fuel hose for transportation of gasoline, alcohol-containing gasoline, diesel fuel or the like.

2. Description of the Art

With growing worldwide awareness of environmental issues, the control of the amount of hydrocarbon vapor emission from an automotive fuel hose has been enhanced. Particularly in the United States, stringent regulations against vapor emission have recently come into effect. To cope with the hydrocarbon vapor emission control in this situation, multi-layer hoses have been proposed which include a layer having low fuel permeability such as composed of a fluororesin, a polyester resin or a polyphenylene sulfide (PPS) resin. A multi-layer hose including a fluororesin layer has a relatively low permeability. To satisfy a stricter low-permeability requirement, the thickness of a fluororesin layer should be increased, resulting in correspondingly higher costs. On the other hand, since the polyester resin and the PPS resin are higher in permeation resistance than the fluororesin, therefore, a layer composed of the polyester resin or the PPS resin has a satisfactory permeation resistance even if it has a relatively small thickness. Thus, the polyester resin layer and the PPS resin layer are advantageous in terms of costs, but tends to be difficult laminate because of their relatively poor adhesion.

To solve the aforesaid drawback, the following hoses (A) to (E) have been proposed.

As proposed in Japanese Patent No. 3126275, a hose (A) has a five-layer structure consisting of a fluororesin layer, a first adhesive resin layer, a polybutylene naphthalate layer, a second adhesive resin layer and a thermoplastic resin layer stacked in this order from the inner side thereof. The first adhesive resin layer for bonding the fluororesin layer and the polybutylene naphthalate layer is a mixture of a fluorine-containing material and a crystalline polyester or a polyester elastomer blended with a compatibilizer.

As proposed in Japanese Unexamined Patent Publication No. 7-173446 (1995), a hose (B) comprises an inner layer formed by a graft-modified ETFE (a copolymer of ethylene and tetrafluoroethylene) and an outer layer formed by a polybutylene terephthalate provided on an outer peripheral surface of the inner layer.

As proposed in International Publication No. WO98/58973, a hose (C) has a laminated structure of a layer comprising tetrafluoroethylene copolymer having terminals modified with polycarbonate and a layer comprising at least one other polymer such as a polyamide resin, a polyolefin resin or an epoxy resin.

As proposed in International Publication No. WO98/55557, a hose (D) has a laminated structure of a layer of a copolymer formed from monomers consisting of (a) a fluorine-containing ethylene monomer having a carboxyl group or a carboxylate and (b) a fluorine-containing ethylene monomer capable of copolymerization with the above-mentioned (a) and not containing any of the above-mentioned functional groups, and a layer comprising a thermoplastic resin.

As proposed in International Publication No. WO99/45044, a hose (E) has a laminated structure of a layer comprising a fluorine-containing ethylene polymer having a carbonate group or a carboxylic halide group and a layer comprising at least one other polymer such as a polyamide resin, a polyester resin or a polycarbonate resin.

However, hose (A) is disadvantageous in that adhesion between the innermost fluororesin layer and the intermediate polybutylene naphthalate layer is very poor. If the adhesion between the inner layer and the intermediate polybutylene naphthalate layer which serves to prevent the permeation of a fuel is insufficient, the inner layer tends to delaminate, thereby reducing the inner space of the hose. This may result in clogging of the hose or reduction in the flow rate of the fuel through the hose. Since the first adhesive resin layer for bonding the fluororesin layer and the polybutylene naphthalate layer is formed by a mixture containing a fluorine-containing material, the resultant layer is disadvantageous in that impact resistance is poor and cost becomes high.

When forming an adhesive layer by a mixture of a polyester-containing material and a fluororesin, such as the above hose (A), a large amount of the fluororesin is required, in terms of weight, due to its high specific gravity, resulting in high cost. In addition, the resultant hose formed of a mixture including a fluororesin has a drawback of inferior physical property because a fluororesin has low affinity with a polyester-containing material.

Since the outer layer of the above hose (B) is formed of a polybutylene terephthalate, the resultant hose has high fuel permeability and poor hydrolytic resistance due to hydrolysis with alcohol or water contained in the fuel. The above hoses (C) to (E) are insufficient in fuel permeability, impact resistance and inter-layer adhesion.

In view of the foregoing, it is an object of the present invention to provide an automotive fuel hose having low fuel permeability, and excellent impact resistance, hydrolysis resistance and inter-layer adhesion.

### SUMMARY OF THE INVENTION

In accordance with the present invention to achieve the aforesaid object, there is provided an automotive fuel hose, which comprises: a tubular inner layer in which fuel is adapted to flow, the inner layer comprising a fluororesin having a functional group; a low fuel permeability layer provided about an outer peripheral surface of the inner layer comprising a polyester resin having a naphthalene ring; and an adhesive layer interposed between and bonding the inner layer and the low fuel permeability layer comprising a blend of polyamide resin and polyester resin.

The inventors of the present invention conducted intensive studies to provide an automotive fuel hose having low fuel permeability, and excellent impact resistance, hydrolysis resistance and inter-layer adhesion. As a result, it was found that, when an inner layer is formed by a fluororesin having a functional group, a low fuel permeability layer is formed by a polyester resin having a naphthalene ring about an outer peripheral surface of the inner layer, and an adhesive layer is formed by a blend of polyamide resin and polyester resin and is interposed between the inner layer and the low fuel permeability layer, the aforesaid object has been achieved in attaining the present invention. This is because the functional groups of the fluororesin for forming the inner layer improve adhesion with the polyamide resin for forming the adhesive layer, so that interlaminar adhesion can be improved between the inner layer and the adhesive layer. Further, since both the adhesive layer and the low fuel permeability layer are formed by polyester materials, adhesion is also strong between these polyester materials. As a result, the interlaminar adhesion becomes strong between the inner layer and the low fuel permeability layer, so that the impact resistance is improved. Still further, since the inner layer is formed by a fluororesin, sour gasoline resistance is excellent. Also, since the low fuel permeability layer is formed by a polyester resin having a naphthalene ring, the layer has low fuel permeability and its hydrolysis resistance is excellent.

The inventive automotive hose comprises a tubular inner layer comprising a fluororesin having a functional group; an adhesive layer comprising a blend of polyamide resin and polyester resin; and a low fuel permeability layer comprising a polyester resin having a naphthalene ring. Therefore, the functional groups of the fluororesin for forming the inner layer improve adhesion with the polyamide resin forming the adhesive layer, so that interlaminar adhesion can be improved between the inner layer and the adhesive layer. Further, since both the adhesive layer and the low fuel permeability layer are formed by polyester materials, adhesion is also strong between these polyester materials. As a result, the interlaminar adhesion becomes strong between the inner layer and the low fuel permeability layer, so that the impact resistance is improved. Still further, since the inner layer is formed by a fluororesin, sour gasoline resistance is excellent. Also, since the low fuel permeability layer is formed by a polyester resin having a naphthalene ring, the hose has low fuel permeability and its hydrolysis resistance is excellent. Even still further, the adhesive layer is provided between the inner layer and the low fuel permeability layer so that a suitable impact resistance can be obtained by thickening the adhesive layer. As a result, it makes it possible to thin the inner layer formed by a fluororesin, resulting in lowered cost.

When the adhesive layer is formed by a mixture including a compatibilizer in addition to the polyamide resin and the polyester resin, both the adhesion between the inner layer and the adhesive layer and the adhesion between the adhesive layer and the low fuel permeability layer are improved. Therefore, the interlaminar adhesion becomes strong between the inner layer and the low fuel permeability layer, so that the impact resistance is improved.

When the polyester resin having a naphthalene ring for forming the low fuel permeability layer is either a polybutylene naphthalate (PBN) or a polyethylene naphthalate (PEN), low fuel permeability with respect to alcohol-containing gasoline is excellent, which improves the overall low fuel permeability of the hose.

When the functional group of the fluororesin is at least one selected from the group consisting of an epoxy group, a hydroxyl group, a carboxylic anhydride residual group, a carboxylic acid group, an acrylate group, a carbonate group and an amino group, adhesion between the inner layer and the adhesive layer is improved, so that the impact resistance is further improved.

### BRIEF DESCRIPTION OF THE DRAWING

The sole FIGURE of the drawing is a diagram illustrating the construction of an exemplary fuel hose according to the present invention.

### DESCRIPTION OF THE PREFERRED EMBODIMENTS

Embodiments of the present invention will hereinafter be described in detail.

As shown in FIGURE, an automotive fuel hose according to one embodiment of the present invention includes an inner layer 1 in which fuel is circulated, an adhesive layer 2 provided on an outer peripheral surface of the inner layer 1, and a low fuel permeability layer 3 provided on an outer peripheral surface of the adhesive layer.

A fluororesin having a functional group is employed as a material for the inner layer 1. The fluororesin is not particularly limited, but examples thereof include a copolymer of ethylene and tetrafluoroethylene (ETFE); a copolymer of tetrafluoroethylene, hexafluoropropylene and vinylidene fluoride (THV); a vinylidene fluoride resin (PVDF); a copolymer of tetrafluoroethylene and hexafluoropropylene (FEP); a copolymer of ethylene and chlorotrifluoroethylene (ECTFE); a copolymer of vinylidene fluoride and hexafluoropropylene; a copolymer of vinylidene fluoride and chlorotrifluoroethylene; a copolymer of vinylidene fluoride and tetrafluoroethylene; a copolymer of vinylidene fluoride, tetrafluoroethylene, hexafluoropropylene and perfluoroalkoxyvinyl ether; and a copolymer of tetrafluoroethylene, vinylidene fluoride, hexafluoropropylene and perfluoroalkoxyvinyl ether. These fluororesins may be used either alone or in combination. Among these fluororesins, ETFE, THV and PVDF are particularly preferred because of their excellent workability.

The functional group for the fluororesin is not particularly limited, but preferable examples thereof include an epoxy group, a hydroxyl group, a carboxylic anhydride residual group, a carboxylic acid group, an acrylate group, a carbonate group and an amino group.

The fluororesin having the functional group may be obtained, for example, by grafting a compound having a functional group into the fluororesin or copolymerizing a compound having a functional group into the main chain or at a terminal of the fluororesin.

The inner layer 1 may be electrically conductive so as not to charge the fuel with static electricity which is mainly generated by a fuel pump. Thus, an accident such as ignition of the fuel caused by a spark can effectively be prevented. In this case, an electrically conductive material such as carbon black, carbon-nano tubes, metal powder, metal fiber, metal oxide powder, metal oxide fiber, metal oxide whisker or carbon fiber preferably is blended in the aforesaid inner layer material. When the inner layer is thus imparted with electrical conductivity, the inner layer (electrically conductive layer) preferably has a surface electric resistance of not higher than 10⁸Ω, particularly preferably not higher than 10⁷Ω. The proportion of the electrically conductive material is preferably determined so that the surface electrical resistance falls within the aforesaid range.

The adhesive layer 2 provided on an outer peripheral surface of the inner layer 1 is composed of a blend of a polyamide resin and a polyester resin.

Examples of the polyamide resin include polyamide 6 (PA6), polyamide 66 (PA66), polyamide 99 (PA99), polyamide 610 (PA610), polyamide 612 (PA612), polyamide 11 (PA11), polyamide 912 (PA912), polyamide 12 (PA12), a copolymer of polyamide 6 and polyamide 66 (PA6/66) and a copolymer of polyamide 6 and polyamide 12 (PA6/12), which may be used either alone or in combination.

The polyamide resin may include those which are modified by a functional group. Among them, those groups which have many end amino groups are preferred. The functional group is not particularly limited, but preferable examples thereof include an epoxy group, a hydroxyl group, a carboxylic anhydride residual group, a carboxylic acid group, an acrylate group, a carbonate group and an amino group.

Examples of the polyester resins include, for example, a polybutylene terephthalate (PET), a polybutylene naphthalate (PBN), a polyethylene terephthalate (PET), a polyethylene naphthalate (PEN), a PBT thermoplastic elastomer (PBT-TPEE) and a PBN thermoplastic elastomer (PBN-TPEE), which may be used either alone or in combination. Among them PBT-TPEE and PBN-TPEE are preferred.

The polyester resin may include those which are modified by a functional group. The functional group is not particularly limited, but preferable examples thereof include an epoxy group, a hydroxyl group, a carboxylic anhydride residual group, a carboxylic acid group, an acrylate group, a carbonate group and an amino group.

The blending volume ratio of the polyamide resin and the polyester resin is preferably within a ratio of 20/80 to 80/20, more preferably 25/75 to 75/25. When the blending volume ratio of the polyamide resin is less than 20, adhesion with the fluororesin having a functional group for forming the inner layer 1 tends to deteriorate. On the other hand, when the blending volume ratio of the polyamide resin exceeds 80, adhesion with the polyester resin having a naphthalene ring for forming the low fuel permeability layer 3 tends to deteriorate because the volume ratio of the polyester resin decreases.

Further, a compatibilizer may be added to the polyamide resin and the polyester resin as a material for forming the adhesive layer 2. When a compatibilizer is added, adhesion is improved both between the inner layer 1 and the adhesive layer 2 and between the adhesive layer 2 and the low fuel permeability layer 3. For this reason, the interlaminar adhesion between the inner layer 1 and the low fuel permeability layer 3 is also improved so that impact resistance is improved.

Examples of the compatibilizer include, for example, ethylene-glycidyl methacrylate (EGMA), modified EGMA, an ethylene-glycidyl methacrylate-vinyl acetate copolymer, an ethylene-glycidyl methacrylate-methyl acrylate copolymer, an ethylene-methyl acrylate copolymer, an ethylene-methyl acrylate-acrylate copolymer, an ethylene-ethyl acrylate copolymer (EEA), modified EEA, a modified ethylene-ethyl acrylate-maleic anhydride copolymer, an ethylene-methacrylate copolymer, acrylic rubber, an ethylene-vinyl acetate copolymer (EVAc), modified EVAc, modified polypropylene (PP), modified polyethylene (PE), an ethylene-ester acrylate-maleic anhydride copolymer, an epoxidized styrene-butadiene-styrene block copolymer (epoxidized SBS), an epoxidized styrene-ethylene-butylene-styrene block copolymer (epoxidized SEBS), acid-modified SBS, acid-modified SEBS, a styrene-isopropenyl oxazoline copolymer, a glycidyl methacrylate-methyl methacrylate copolymer, a glycidyl methacrylate-styrene copolymer and a thermoplastic urethane, which may be used either alone or in combination.

Examples of the modified EGMA include, for example, those which are obtained by grafting polystyrene (PS), polymethyl methacrylate (PMMA), an acrylonitrile-styrene copolymer (AS), a copolymer of PMMA and butyl acrylate, or the like, to EGMA.

Examples of the modified EEA include, for example, those which are obtained by grafting PS, PMMA, AS, a copolymer of PMMA and butyl acrylate, or the like, to EEA; maleic anhydride modified EEA; and silane modified EEA.

Examples of the modified ethylene-ethyl acrylate-maleic anhydride copolymer include, for example, those which are obtained by grafting PS, PMMA, AS, a copolymer of PMMA and butyl acrylate, or the like, to ethylene-ethyl acrylate-maleic anhydride copolymer.

Examples of the modified EVAc include, for example, those which are obtained by grafting PS, PMMA, AS, a copolymer of PMMA and butyl acrylate, or the like, to EVAc.

Examples of the modified PP include, for example, those which are obtained by grafting PS or AS, to PP, and maleic anhydride modified PP.

Examples of the modified PE include, for example, those which are obtained by grafting PS, PMMA, AS, a copolymer of PMMA and butyl acrylate, or the like, to low-density polyethylene (LDPE), and maleic anhydride modified PE.

The blending volume ratio of the mixture of the polyamide resin and the polyester resin to the compatibilizer is preferably within a ratio of 99/1 to 80/20, more preferably 98/2 to 85/15.

The low fuel permeability layer 3 provided on an outer peripheral surface of the adhesive layer 2 is composed of a polyester resin having a naphthalene ring. Such a polyester resin is not particularly limited, but preferable examples thereof include a polybutylene naphthalate (PBN) and a polyethylene naphthalate (PEN).

Polybutylene naphthalate (PBN) is a resin obtained by condensation between tetramethylene glycol and 2,6-naphthalenedicarboxylic acid or its ester compound. Polyethylene naphthalate (PEN) is a resin obtained by condensation between ethylene glycol and 2,6-naphthalenedicarboxylic acid or its ester compound.

The PBN or the PEN may be copolymerized with an ether segment or an ester segment so as to be used as a thermoplastic elastomer having flexibility within a range in such a manner to satisfy the low permeability requirements. Further, the PBN or the PEN may be reacted with a dicarboxylic acid of a fatty acid in addition to a naphthalene dicarboxylic acid in such a manner to satisfy the low permeability requirements. Alternatively, the PBN or the PEN may be mixed with an elastomer such as an olefin elastomer or a core-shell elastomer in such a manner to satisfy the low permeability requirements.

The PEN or the PEN may preferably have a permeability coefficient of not higher than 0.08. The permeability coefficient indicates a permeability coefficient (mg·mm/cm²/day/atm) of fuel composed of 90 volume % Fuel C (50% by volume of toluene+50% by volume of isooctane) and 10 volume % ethanol at 40° C. The permeability coefficient is measured in conformity with “Method A” of Japanese Industrial Standard (JIS) K7126.

The PBN or the PEN preferably has a viscosity of 90 to 260cm³/g in consideration of a balance between extrudability and its resistances to impact, heat and hydrolysis. The viscosity is determined at 35° C. in conformity with ASTM D 2857 by employing a solution obtained by dissolving the PBN or the PEN in a concentration of 0.005 g/cm³ in a solvent mixture of phenol and tetrachloroethane.

The structure of the inventive automotive fuel hose is not limited to that shown in FIGURE, in that an outer layer (not shown) may be provided on an outer peripheral surface of the low fuel permeability layer 3 in consideration of providing flexibility suitable for hoses as well as chipping resistance. It is preferred that such an outer layer is provided on an outer peripheral surface of the low fuel permeability layer 3, because impact resistance at a low temperature is improved.

The material for the outer layer is not particularly limited, but examples thereof include polyamide resins such as polyamide 6 (PA6), polyamide 66 (PA66), polyamide 99 (PA99), polyamide 610 (PA610), polyamide 612 (PA612), polyamide 11 (PA11), polyamide 912 (PA912), polyamide 12 (PA12), a copolymer of polyamide 6 and polyamide 66 (PA6/66) and a copolymer of polyamide 6 and polyamide 12 (PA6/12), a thermoplastic polyester elastomer (TPEE), a thermoplastic polyolefin elastomer (TPO), a thermoplastic polyamide elastomer (TPAE), a thermoplastic polystyrene elastomer (TPS), polypropylene (PP) and polyethylene (PE), which may be used either alone or in combination. The outer layer is not limited to a single-layer structure and may have a multi-layer structure of two or more layers.

In addition, the structure of the inventive hose is not limited to a three-layer structure as shown in FIGURE, but an innermost layer (not shown) may be formed by a fluororesin not having a functional group on an inner peripheral surface of the inner layer 1. The innermost layer may be electrically conductive or electrically non-conductive. Further, the structure of the inner layer 1 is not limited to a single-layer structure but may be a multi-layer structure consisting of two or more sublayers. For example, the inner layer 1 may have a double-layer structure consisting of an electrically conductive inner sublayer and an electrically non-conductive outer sublayer.

Further, a second adhesive layer may be provided between the low fuel permeability layer 3 and the outer layer. The material for the second adhesive layer may preferably be the same as that of the adhesive layer 2 formed between the inner layer 1 and the low fuel permeability layer 3, that is, a blend of the polyamide resin and the polyester resin, but may not be particularly limited thereto. In addition, the outer layer provided on an outer peripheral surface of the low fuel permeability layer 3 is not limited to a single-layer structure and may have a multi-layer structure of two or more layers.

The inventive automotive fuel hose shown in FIGURE is produced, for example, by the following process. First, each material is prepared for an inner layer 1, an adhesive layer 2 and a low fuel permeability layer 3, respectively. Each material is extruded by means of an inner-layer material extruder, an adhesive-layer material extruder and a low fuel permeability material extruder, respectively, and is combined in a die. The thus molten material is co-extruded into a tubular shape, which is passed through a sizing die, so that the intended fuel hose wherein the adhesive layer 2 is laminated onto an outer peripheral surface of the inner layer 1 and further the low fuel permeability layer 3 is laminated onto an outer peripheral surface of the adhesive layer is produced.

When an outer layer is formed on an outer peripheral surface of the low fuel permeability layer 3, additional material is also prepared for an outer layer. Each material is extruded by means of an inner-layer material extruder, an adhesive-layer material extruder, a low fuel permeability material extruder, and an outer-layer extruder, respectively, and is combined in a die. The thus molten material is co-extruded into a tubular shape, which is passed through a sizing die, so that the intended fuel hose having a four-layer structure is produced.

The formation of the inner layer 1 having a double-layer structure is achieved by simultaneously extruding each material from separate extruders and combining the resulting sublayers in a die. For formation of the outer layer having a double-layer structure, the outer layer may be formed likewise in the aforesaid manner. Further, when a hose is formed into a corrugated hose, the aforesaid molten material co-extruded into a tubular shape is passed through a corrugation forming machine so that a corrugated hose of specified dimensions may be formed.

The inventive automotive fuel hose thus produced preferably has an inner diameter of 2 to 40 mm, particularly preferably 2.5 to 36 mm, and an outer diameter of 3 to 44 mm, particularly preferably 4 to 40 mm. The inner layer 1 preferably has a thickness of 0.02 to 1.0 mm, particularly preferably 0.05 to 0.6 mm. The adhesive layer 2 preferably has a thickness of 0.02 to 1.0 mm, particularly preferably 0.05 to 0.6 mm. The low fuel permeability layer 3 preferably has a thickness of 0.02 to 0.8 mm, particularly preferably 0.05 to 0.6 mm. Further, when an outer layer is formed, the outer layer generally has a thickness of 0.2 to 1.5 mm, preferably 0.3 to 1.0 mm.

The inventive automotive fuel hose may preferably be used as a transportation hose for automotive fuel such as gasoline, alcohol-containing gasoline, diesel fuel, compressed natural gas (CNG), liquefied petroleum gas (LPG), but is not limited thereto. The inventive automotive fuel hose may be used as a transportation hose for methanol, hydrogen, dimethylether (DME) or the Like for applications such as for fuel cell-powered vehicles.

Next, an explanation will be given to the Examples and the Comparative Examples.

Prior to the explanation of the Examples and the Comparative Examples, the ingredients employed therein were prepared.

Carboxylic Anhydride-Modified ETFE

Fluon AH-2000 available from Asahi Glass Co., Ltd.

Epoxy-modified ETFE

Epoxy-modified ETFE was prepared by blending 2 parts by weight (just abbreviated as ‘parts’, hereinafter) of glycidyl methacrylate and 2 parts of dicumyl peroxide relative to 100 parts of ETFE and kneading the resultant mixture by means of a twin screw extruder.

Electrically Conductive Carboxylic Anhydride-Modified ETFE

Electrically conductive carboxylic anhydride-modified ETFE was prepared by blending 18 parts of acetylene black relative to 100 parts of carboxylic anhydride-modified ETFE (Fluon AH-2000 available from Asahi Glass Co., Ltd.)

Electrically Conductive ETFE

Fluon CB-4015L available from Asahi Glass Co., Ltd.

ETFE

Fluon LM730AP available from Asahi Glass Co., Ltd.

Epoxy Modified THV

Epoxy-modified THV was prepared by blending 4 parts of glycidyl methacrylate and 2 parts of dicumyl peroxide relative to 100 parts of THV and kneading the resultant mixture by means of a twin screw extruder.

PBN

A condensation product (TQB-OT available from Teijin Chemicals Ltd.) of tetramethylene glycol and 2,6-naphthalenedicarboxylic acid.

PEN

A condensation product (TN8065 available from Teijin Chemicals Ltd.) of ethylene glycol and 2,6-naphthalenedicarboxylic acid.

PBT

CELANEX2001 available from Polyplastics, Co., Ltd.

TPEE-1

PBT-TPEE (HYTREL 5577R07 available from DuPont-Toray Co., Ltd. of Tokyo, Japan.)

TPEE-2

PBN-TPEE (PELPRENE EN5030 available from Toyobo Co., Ltd.)

TPEE-3

PBT-TPEE (HYTREL 5557 available from DuPont-Toray Co., Ltd. of Tokyo, Japan.)

PA12-1

UBESTA 3030B available from Ube Industries, Ltd.

PA12-2

Rilsan AESN O P20TL available from Atofina Japan K. K.

PA6

UBE nylon 1030B available from Ube Industries, Ltd.

Compatibilizer-1

Epoxidized SBS (EPOFRIEND AT501 available from Daicel Chemical Industries, Ltd.)

Compatibilizer-2

Modified EGMA (MODIPER A4300 available from NOF Corporation) obtained by grafting a copolymer of PMMA and butyl acrylate to EGMA.

BLEND-1

A material obtained by kneading PA12-1 and TPEE-2 at a volume ratio 50/50.

BLEND-2

A material obtained by kneading PA12-1, TPEE-2 and Compatibilizer-1 at a volume ratio of 45/45/10.

BLEND-3

A material obtained by kneading PA12-1, TPEE-2 and Compatibilizer-1 at a volume ratio of 54/36/10.

BLEND-4

A material obtained by kneading PA12-1, TPEE-2 and Compatibilizer-1 at a volume ratio of 36/54/10.

BLEND-5

A material obtained by kneading PA6, TPEE-2 and Compatibilizer-1 at a volume ratio of 45/45/10.

BLEND-6

A material obtained by kneading PA12-1, TPEE-1 and Compatibilizer-1 at a volume ratio of 45/45/10.

BLEND-7

A material obtained by kneading PA12-1, TPEE-2 and Compatibilizer-2 at a volume ratio of 45/45/10.

BLEND-8

A material obtained by kneading terminal amine modified PA6 (UBE nylon G1013 available from Ube Industries, Ltd.), TPEE-2 and Compatibilizer-1 at a volume ratio of 54/36/10.

BLEND-9

A material obtained by kneading terminal amine modified PA6 (UBE nylon G1013 available from Ube Industries, Ltd.), TPEE-2 and Compatibilizer-1 at a volume ratio of 23/67/10.

BLEND-10

A material obtained by kneading PA12-1, TPEE-3 and Compatibilizer-1 at a volume ratio of 67/23/10.

BLEND-11

A material obtained by kneading terminal amine modified PA12 (UBESTA3020UX1 available from Ube Industries, Ltd.), TPEE-2 and Compatibilizer-1 at a volume ratio of 42/48/10.

### EXAMPLE 1

Each extruder for an inner layer, an adhesive layer, a low fuel permeability layer and an outer layer was prepared, respectively. Each material was extruded by each extruder, and was combined in a die, and then passed through a sizing die, whereby an inner layer, an adhesive layer (A), a low fuel permeability layer and an outer layer were laminated successively in this order. Thus, a fuel hose was produced which has an inner diameter of 6 mm and an outer diameter of 8 mm.

### EXAMPLE 2 TO 21 AND COMPARATIVE EXAMPLES 1 TO 3

Fuel hoses were produced in substantially the same manner as in Example 1, except that an innermost layer material, inner layer materials, adhesive layer (A) materials, low fuel permeability layer materials, adhesive layer (B) materials, and outer layer materials shown in Tables 1 to 3 were employed.

The properties of the fuel hoses of Examples and Comparative Examples were evaluated in the following manner. The results are shown in Tables 1 to 3.

Gasoline Permeability

Opposite end portions of a 10 m long fuel hose (having an inner diameter of 6 mm) were each expanded to an inner diameter of 10 mm by means of a cone-shaped jig. Then, two metal pipes were prepared which each had an outer diameter of 8 mm with two bulged portions each having an outer diameter of 10 mm and with each one end thereof having a rounded outer periphery. These metal pipes were respectively press-fitted into opposite end portions of the hose. A blind cap was threadingly attached to one of the metal pipes, and a metal valve was attached to the other metal pipe. Thereafter, Indolene gasoline (containing 10 vol % ethanol) was supplied into the fuel hose through the metal valve, and the fuel hose was sealed. The fuel hose was allowed to stand at 40° C. for 3000 hours (the Indolene gasoline was changed every week). Then, fuel permeation was measured for three days on the basis of a Diurnal Breathing Loss (DBL) pattern by the Sealed Housing for Evaporative Detection (SHED) method in accordance with California Air Resources Board (CARB). Then, fuel permeation per meter of the hose was determined on a day when the maximum fuel permeation was detected. In Tables 1 to 3, the notation “<0.1” indicates that the measured fuel permeation was below the measurement limitation (0.1 mg/m/day) of the aforesaid measurement method.

Hydrolysis Resistance

Each fuel hose was filled with pure water. Then, after being aged at 80° C. for 1,000 hours, the fuel hose was bent at an angle of 180°. The low fuel permeability layer was visually inspected for evaluation of the hydrolysis resistance. In Tables 1 to 3, the symbol ◯ indicates that no cracking was observed on the low fuel permeability layer, and the symbol × indicates that the low fuel permeability layer was cracked.

Adhesion

The fuel hoses were each longitudinally cut into four strips. By using one of the strips, a peel force (N/cm) required for separating the adhesive layer (A) from its internal layer was determined. Separately, a peel force (N/cm) required for separating the adhesive layer (A) from its external layer was determined in the same manner as described above.

Impact Resistance

Soon after each fuel hose was allowed to stand at −40° C. for 4 hours, a drop-weight test was conducted in conformity with JASO M317 in such a manner that a falling weight (round rod having a diameter of 32 mm and 450 g and both ends thereof with 16 mm radius of curvature, respectively) was dropped from the height of 305 mm onto each fuel hose. Then, each hose was cut into halves longitudinally, and occurrence of abnormality was visually evaluated on both inner and outer sides of each fuel hose. In Tables 1 to 3, the symbol ◯ indicates that no cracking was observed on both sides of the fuel hose, and the symbol × indicates that either or both sides of the fuel hose was cracked.

TABLE 1

| | EXAMPLE | | | | | | | |
|---|---|---|---|---|---|---|---|---|
| | 1 | 2 | 3 | 4 | 5 | 6 | 7 | 8 |
| Inner layer | Carboxylic | Carboxylic | Carboxylic | Carboxylic | Carboxylic | Carboxylic | Carboxylic | Carboxylic |
| | anhydride- | anhydride- | anhydride- | anhydride- | anhydride- | anhydride- | anhydride- | anhydride- |
| | modified | modified | modified | modified | modified | modified | modified | modified |
| | ETFE | ETFE | ETFE | ETFE | ETFE | ETFE | ETFE | ETFE |
| Adhesive layer (A) | Blend-1 | Blend-2 | Blend-3 | Blend-4 | Blend-9 | Blend-10 | Blend-2 | Blend-2 |
| Low fuel permeability | PBN | PBN | PBN | PBN | PBN | PBN | PEN | PBN |
| layer | | | | | | | | |
| Adhesive layer (B) | — | — | — | — | — | — | — | Blend-2 |
| Outer layer | TPEE-1 | TPEE-1 | TPEE-1 | TPEE-1 | TPEE-1 | TPEE-1 | TPEE-1 | PA12-2 |
| Thickness (μm) | | | | | | | | |
| Inner Layer | 100 | 100 | 100 | 100 | 100 | 100 | 100 | 100 |
| Adhesive layer (A) | 200 | 200 | 200 | 200 | 200 | 200 | 200 | 200 |
| Low fuel permeability | 100 | 100 | 100 | 100 | 100 | 100 | 100 | 100 |
| layer | | | | | | | | |
| Adhesive layer (B) | — | — | — | — | — | — | — | 100 |
| Outer layer | 600 | 600 | 600 | 600 | 600 | 600 | 600 | 500 |
| Gasoline permeability | <0.1 | <0.1 | <0.1 | <0.1 | <0.1 | <0.1 | <0.1 | <0.1 |
| (mg/m/day) | | | | | | | | |
| Hydrolysis resistance | ◯ | ◯ | ◯ | ◯ | ◯ | ◯ | ◯ | ◯ |
| Adhesion (N/cm) | | | | | | | | |
| with internal layer | 20 | 40 | 44 | 30 | 18 | (*1) | 34 | 40 |
| with external layer | (*1) | (*1) | 30 | (*1) | (*1) | 15 | 38 | (*1) |
| Impact resistance | ◯ | ◯ | ◯ | ◯ | ◯ | ◯ | ◯ | ◯ |

(*1) Material was ruptured.

TABLE 2

| | EXAMPLE | | | | | | | |
|---|---|---|---|---|---|---|---|---|
| | 9 | 10 | 11 | 12 | 13 | 14 | 15 | 16 |
| Inner layer | Electrically | Epoxy- | Carboxylic | Carboxylic | Carboxylic | Carboxylic | Electrically | Carboxylic |
| | conductive | modified | anhydride- | anhydride- | anhydride- | anhydride- | conductive | anhydride- |
| | carboxylic | ETFE | modified | modified | modified | modified | carboxylic | modified |
| | anhydride- | | ETFE | ETFE | ETFE | ETFE | anhydride- | ETFE |
| | modified | | | | | | modified | |
| | ETFE | | | | | | ETFE | |
| Adhesive layer (A) | Blend-2 | Blend-2 | Blend-5 | Blend-6 | Blend-7 | Blend-8 | Blend-8 | Blend-8 |
| Low fuel permeability | PBN | PBN | PBN | PBN | PBN | PBN | PBN | PBN |
| layer | | | | | | | | |
| Adhesive layer (B) | Blend-2 | — | — | — | — | — | — | Blend-2 |
| Outer layer | PA12-2 | TPEE-1 | TPEE-1 | TPEE-1 | TPEE-1 | TPEE-1 | TPEE-1 | PA12-2 |
| Thickness (μm) | | | | | | | | |
| Inner layer | 100 | 100 | 100 | 100 | 100 | 100 | 100 | 100 |
| Adhesive layer (A) | 200 | 200 | 200 | 200 | 200 | 200 | 200 | 200 |
| Low fuel permeability | 100 | 100 | 100 | 100 | 100 | 100 | 100 | 100 |
| layer | | | | | | | | |
| Adhesive layer (B) | 100 | — | — | — | — | — | — | 100 |
| Outer layer | 500 | 600 | 600 | 600 | 600 | 600 | 600 | 500 |
| Gasoline permeability | <0.1 | <0.1 | <0.1 | <0.1 | <0.1 | <0.1 | <0.1 | <0.1 |
| (mg/m/day) | | | | | | | | |
| Hydrolysis resistance | ◯ | ◯ | ◯ | ◯ | ◯ | ◯ | ◯ | ◯ |
| Adhesion (N/cm) | | | | | | | | |
| with internal layer | 39 | 37 | 41 | 42 | 38 | 52 | 50 | 51 |
| with external layer | (*1) | (*1) | (*1) | (*1) | (*1) | (*1) | (*1) | (*1) |
| Impact resistance | ◯ | ◯ | ◯ | ◯ | ◯ | ◯ | ◯ | ◯ |

(*1) Material was ruptured.

TABLE 3

| | | | | | | COMPARATIVE | | |
|---|---|---|---|---|---|---|---|---|
| | EXAMPLE | | | | | EXAMPLE | | |
| | 17 | 18 | 19 | 20 | 21 | 1 | 2 | 3 |
| Innermost layer | — | — | Electrically | — | — | — | — | — |
| | | | conductive | | | | | |
| | | | ETFE | | | | | |
| Inner layer | Electrically | Electrically | Carboxylic | Epoxy- | Electrically | ETFE | ETFE | Carboxylic |
| | conductive | conductive | anhydride- | modified | conductive | | | anhydride- |
| | carboxylic | carboxylic | modified | THV | carboxylic | | | modified |
| | anhydride- | anhydride- | ETFE | | anhydride- | | | ETFE |
| | modified | modified | | | modified | | | |
| | ETFE | ETFE | | | ETFE | | | |
| Adhesive layer (A) | Blend-8 | Blend-2 | Blend-2 | Blend-2 | Blend-11 | Blend-2 | Blend-7 | Blend-2 |
| Low fuel permeability layer | PBN | PBN | PBN | PBN | PBN | PBN | PBN | PBT |
| Adhesive layer (B) | Blend-2 | — | — | — | Blend-2 | — | — | — |
| Outer layer | PA12-2 | TPEE-1 | TPEE-1 | TPEE-1 | PA12-2 | TPEE-1 | TPEE-1 | TPEE-1 |
| Thickness (μm) | | | | | | | | |
| Innermost layer | — | — | 50 | — | — | — | — | — |
| Inner layer | 100 | 100 | 100 | 100 | 100 | 100 | 100 | 100 |
| Adhesive layer (A) | 200 | 200 | 150 | 200 | 200 | 200 | 200 | 200 |
| Low fuel permeability layer | 100 | 100 | 100 | 100 | 100 | 100 | 100 | 100 |
| Adhesive layer (B) | 100 | — | — | — | 100 | — | — | — |
| Outer layer | 500 | 600 | 600 | 600 | 500 | 600 | 600 | 600 |
| Gasoline permeability | <0.1 | <0.1 | <0.1 | <0.1 | <0.1 | <0.1 | <0.1 | 4 |
| (mg/m/day) | | | | | | | | |
| Hydrolysis resistance | ◯ | ◯ | ◯ | ◯ | ◯ | ◯ | ◯ | X |
| Adhesion (N/cm) | | | | | | | | |
| with internal layer | 50 | 37 | 40 | 33 | 47 | 0 | 0 | 39 |
| with external layer | (*1) | (*1) | (*1) | (*1) | (*1) | (*1) | (*1) | (*1) |
| Impact resistance | ◯ | ◯ | ◯ | ◯ | ◯ | X | X | ◯ |

(*1) Material was ruptured.

As can be understood from the results, the fuel hoses of the Examples had low fuel permeability, and had excellent hydrolysis resistance, adhesion and impact resistance.

On the other hand, the fuel hoses of Comparative Examples 1 and 2, whose inner layer was formed by ordinary ETFE having no functional group, was inferior in adhesion between the inner layer and the adhesive layer (A) so as to have inferior impact resistance. The fuel hose of Comparative Example 3, whose low fuel permeability layer was formed by PBT, had inferior low fuel permeability and hydrolysis resistance.

As mentioned above, the inventive automotive fuel hose is favorably used for transportation of an automotive fuel, and more specifically, to an automotive fuel hose for transportation of gasoline, alcohol-containing gasoline, diesel fuel or the like.

What is claimed is:

1. An automotive fuel hose, which comprises: a tubular inner layer in which fuel is adapted to flow, the inner layer comprising a fluororesin having a functional group; a low fuel permeability layer provided about an outer peripheral surface of the inner layer comprising a polyester resin having a naphthalene ring; and an adhesive layer for bonding the inner layer and the low fuel permeability layer comprising a blend of polyamide resin and polyester resin.

2. An automotive fuel hose as set forth in claim 1, wherein the adhesive layer further comprises a compatibilizer.

3. An automotive fuel hose as set forth in claim 2, wherein the polyester resin having a naphthalene ring for the low fuel permeability layer is either a polybutylene naphthalate or a polyethylene naphthalate.

4. An automotive fuel hose as set forth in claim 1, wherein the polyester resin having a naphthalene ring for the low fuel permeability layer is either a polybutylene naphthalate or a polyethylene naphthalate.

5. An automotive fuel hose as set forth in claim 4, wherein the functional group of the fluororesin is at least one functional group selected from the group consisting an epoxy group, a hydroxyl group, a carboxylic anhydride residual group, a carboxylic acid group, an acrylate group, a carbonate group and an amino group.

6. An automotive fuel hose as set forth in claim 1, wherein the functional group of the fluororesin is at least one functional group selected from the group consisting an epoxy group, a hydroxyl group, a carboxylic anhydride residual group, a carboxylic acid group, an acrylate group, a carbonate group and an amino group.

7. An automotive fuel hose as set forth in claim 2, wherein the functional group of the fluororesin is at least one functional group selected from the group consisting an epoxy group, a hydroxyl group, a carboxylic anhydride residual group, a carboxylic acid group, an acrylate group, a carbonate group and an amino group.

8. An automotive fuel hose as set forth in claim 3, wherein the functional group of the fluororesin is at least one functional group selected from the group consisting an epoxy group, a hydroxyl group, a carboxylic anhydride residual group, a carboxylic acid group, an acrylate group, a carbonate group and an amino group.
